(19) United States
(12) Patent Application Publication
(10) Pub. No.: US 2026/0067675 A1
(43) Pub. Date: Mar. 5, 2026

(54) PADDING FOR PRIVACY

(71) Applicant: Cisco Technology, Inc., San Jose, CA (US)

(72) Inventors: Jerome HENRY, Pittsboro, NC (US); Ugo M. CAMPIGLIO, Morges (CH); Javier I. CONTRERAS ALBESA, Sant Cugat del Valles (ES); Domenico FICARA, Essertines-Sur-Yverdon (CH); Robert E. BARTON, Richmond (CA)

(21) Appl. No.: 19/266,116

(22) Filed: Jul. 10, 2025

Related U.S. Application Data
(60) Provisional application No. 63/690,949, filed on Sep. 5, 2024.

(51) Int. Cl. H04W 12/02; H04W 28/06

(52) U.S. Cl. CPC H04W 12/02; H04W 28/065

(57) ABSTRACT

Described herein is a network that uses padding to obscure transmission period or size. A wireless device performs an operation that includes transmitting, to an access point, a first message at a first time and transmitting, to the access point, a second message at a second time after the first time. A difference between the second time and the first time is a transmission period. The operation also includes generating a padding message comprising a first padding header and first padding data and transmitting, to the access point, the padding message at a third time after the second time. A difference between the third time and the second time is less than the transmission period. The operation further includes transmitting, to the access point, a third message at a fourth time after the third time. A difference between the fourth time and the second time is the transmission period.

### CROSS-REFERENCE TO RELATED APPLICATIONS

This application claims benefit of co-pending U.S. provisional patent application Ser. No. 63/690,949 filed Sep. 5, 2024. The aforementioned related patent application is herein incorporated by reference in its entirety.

### TECHNICAL FIELD

Embodiments presented in this disclosure generally relate to wireless networks. More specifically, embodiments disclosed herein using padding data to obscure the transmission period or size of messages.

### BACKGROUND

Wireless networks (e.g., Wi-Fi networks) implement various techniques (e.g., encryption, media access control address rotation, etc.) to protect the privacy of wireless transmissions. Certain aspects of wireless transmissions, however, may still reveal or indicate the identity of the device or user that made the transmissions. For example, videoconferencing applications and audio call applications may wirelessly transmit messages with fixed sizes and at fixed intervals to ensure the quality of a videoconference or call. Even though these transmissions may be encrypted, it is still possible to determine that the transmissions are communicated from the same device due to their fixed sizes and fixed transmission intervals.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example access point or device in the system of FIG. 1A.

FIG. 2 illustrates an example operation performed by the system of FIG. 1A.

FIG. 3 illustrates an example padding message in the system of FIG. 1A.

FIG. 4 illustrates an example operation performed by the system of FIG. 1A.

FIG. 5A illustrates an example message in the system of FIG. 1A.

FIG. 5B illustrates an example operation performed by the system of FIG. 1A.

FIG. 6 illustrates an example operation performed by the system of FIG. 1A.

FIG. 7 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a wireless network that uses padding data to obscure the transmission period or size of messages. According to an embodiment, a wireless device includes one or more memories and one or more processors communicatively coupled to the one or more memories. The one or more processors, individually or collectively, perform an operation that includes transmitting, to an access point, a first message at a first time and transmitting, to the access point, a second message at a second time after the first time. A difference between the second time and the first time is a transmission period. The operation also includes generating a padding message comprising a first padding header and first padding data and transmitting, to the access point, the padding message at a third time after the second time. A difference between the third time and the second time is less than the transmission period. The operation further includes transmitting, to the access point, a third message at a fourth time after the third time. A difference between the fourth time and the second time is the transmission period.

According to another embodiment, a method includes transmitting, to an access point, a first message at a first time and transmitting, to the access point, a second message at a second time after the first time. A difference between the second time and the first time is a transmission period. The method also includes generating a padding message comprising a first padding header and first padding data and transmitting, to the access point, the padding message at a third time after the second time. A difference between the third time and the second time is less than the transmission period. The method further includes transmitting, to the access point, a third message at a fourth time after the third time. A difference between the fourth time and the second time is the transmission period.

According to another embodiment, an access point includes one or more memories and one or more processors communicatively coupled to the one or more memories. The one or more processors, individually or collectively, perform an operation that includes receiving a first message transmitted by a wireless device at a first time and receiving a second message transmitted by the wireless device at a second time after the first time. A difference between the second time and the first time is a transmission period. The operation also includes receiving a padding message transmitted by the wireless device at a third time after the second time. The padding message includes a first padding header and first padding data. A difference between the third time and the second time is less than the transmission period. The operation further includes discarding the padding data based on the padding header and receiving a third message transmitted by the wireless device at a fourth time after the third time. A difference between the fourth time and the second time is the transmission period.

### EXAMPLE EMBODIMENTS

The present disclosure describes a network that uses padding information to obscure, disguise, or obfuscate the transmission period or the size of transmissions. For example, a device that may be using an application that transmits messages of fixed sizes or at fixed intervals may generate a padding message that includes a padding header and padding data (e.g., lacks a data header and a data payload). As a result, the padding message may include information that is not relevant to or not used by the application, and a receiving access point may discard or disregard the padding message. The device may transmit the padding message in between transmissions made by the application. As a result, the padding message may make it more difficult for a malicious user to determine that the device is transmitting according to the transmission period or at the fixed transmission interval.

As another example, the device may add padding information (e.g., a padding header, padding data, etc.) to messages before transmitting the messages. The size of the padding data may be random, or the padding data may be added until the messages reach a certain size. A receiving access point may discard or disregard the padding information in the messages. In this manner, the padding information in the messages may make it more difficult for a malicious user to determine that the device is transmitting messages of a fixed size.

In certain embodiment, the network provides several technical advantages. For example, the network may improve the privacy of devices and users on the network by obfuscating the transmission period or the size of transmissions. As another example, the network may make it more difficult for malicious users intercepting messages to determine which device on the network transmitted which intercepted messages.

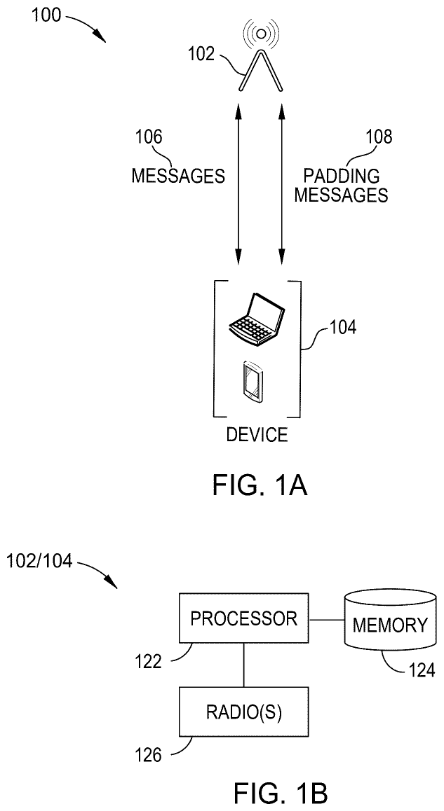

FIG. 1A illustrates an example system 100, which may be a wireless network. As seen in FIG. 1A, the system 100 includes an access point 102 and a device 104. Generally, the access point 102 and the device 104 exchange padding messages, which may obfuscate a transmission period of the device 104.

The access point 102 may be a network device that facilitates wireless communication (e.g., Wi-Fi communication) in the system 100. The device 104 connects to the access point 102, and the access point 102 may facilitate communication to and from the device 104. For example, the access point 102 may receive messages from the device 104 and direct those messages towards their destination. As another example, the access point 102 may receive messages intended for the device 104 and direct those messages to the device 104. The access point 102 may also exchange messages with other access points 102.

The device 104 may be any suitable device that wirelessly connects to an access point 102. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

The access point 102 and the device 104 may implement various features to protect the privacy of the device 104. For example, the access point 102 and the device 104 may encrypt messages 106 exchanged between the access point 102 and the device 104 so that it may be difficult to determine the content of the messages 106 if the messages 106 were intercepted. As another example, the access point 102 or the device 104 may periodically change or rotate a media control access (MAC) address of the access point 102 or device 104 so that it may be difficult to track which access point or device communicated the messages 106 if the messages 106 were intercepted.

In some instances, however, it may still be possible to determine that the messages 106 were transmitted by or to the device 104. For example, a user of the device 104 may be using a videoconferencing application or an audio call application on the device 104. These applications (and other types of applications) typically transmit messages of predetermined or fixed sizes at periodic or fixed intervals. As a result, it may be possible to determine that the messages 106 were being transmitted by the same device based on the messages 106 being of the same size or being transmitted at periodic or fixed intervals.

The access point 102 and the device 104 use padding messages 108 and padding data to obfuscate message size and transmission periods. The padding messages 108 may be messages with irrelevant data. For example, the padding messages 108 may include a padding header and padding data. The padding data may be irrelevant to or unused by the access point 102 or the device 104. As a result, the access point 102 and the device 104 may disregard or discard padding messages 108 when received. The access point 102 and the device 104 may transmit the padding messages 108 in between some transmissions of the messages 106. As a result, the padding messages 108 may create the impression that the access point 102 and the device 104 are transmitting but not at the periodic or fixed interval. Thus, the padding messages 108 may obfuscate the transmission period of the access point 102 or the device 104 and make it more difficult to determine that the device 104 transmitted or received the messages 106.

The access point 102 and the device 104 may also use padding data to obfuscate the size of the messages 106. The messages 106 may include a data header and data that includes the data for the application. The access point 102 and the device 104 may add a padding header and padding data to the messages 106 to increase the size of the messages 106. In some instances, the access point 102 and the device 104 may increase the size of the messages 106 by a random amount. In certain instances, the access point 102 and the device 104 may increase the size of the messages 106 to be a maximum size allowed by the communication protocol. In some instances, the access point 102 and the device 104 may increase the size of the messages 106 such that the messages 106 are the same size as messages transmitted by other devices in the network. As a result, the padding data may create the impression that the messages 106 do not have the same size or that the messages 106 are being transmitted by other devices. Thus, the padding data may obfuscate the size of the messages 106 and make it more difficult to determine that the device 104 transmitted or received the messages 106.

Generally, the access point 102 and the device 104 may use a new type of frame called padded data or padding data. Subtypes may include padded quality of service (QoS) data, padded null, padded QoS data with contention free (CF) acknowledgement, padded QoS data with CF poll, padded QoS data with CF acknowledgement and CF poll. Each type may be identified using the frame control header frame type and subtype field values.

In some embodiments, the access point 102 may suggest that groups of devices 104 of the same basic service set identifier (BSSID) use the same frame size or message size. For example, the access point 102 may include a privacy frame size field or element with an action frame after association or with a broadcast action frame periodically. The frame size may be a parameter of the group epoch, thus leading all devices 104 in a given epoch group to use the same frame sizes. Devices 104 may opt in and adapt dynamically their padding field size to each frame of privacy frame size.

FIG. 1B illustrates an example access point 102 or device 104 of the system 100 of FIG. 1A. As seen in FIG. 1B, the access point 102 and device 104 include a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the access point 102 or the device 104. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the access point 102 or the device 104 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the access point 102 or the device 104 may use one or more of the radios 126 for Wi-Fi communications. The access point 102 or the device 104 may use one or more of the radios 126 to transmit messages and one or more of the radios 126 to receive messages. The access point 102 or the device 104 may include any number of radios 126 to communicate using any number of communication technologies.

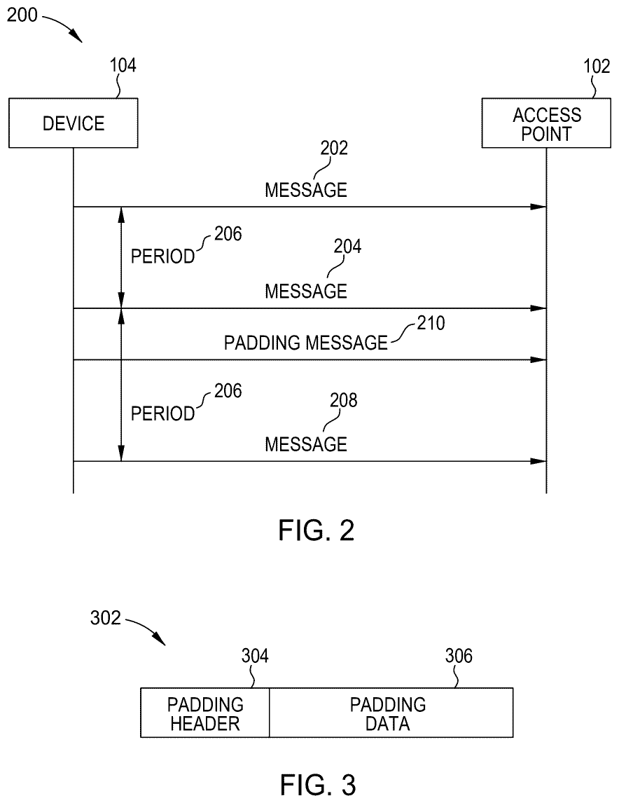

FIG. 2 illustrates an example operation 200 performed by the system 100 of FIG. 1A. Generally, the access point 102 and the device 104 perform the operation 200. By performing the operation 200, the access point 102 and the device 104 obfuscate a transmission period of the device 104.

The access point 102 and the device 104 may transmit messages to each other. As seen in FIG. 2, the device 104 transmits a message 202 and a message 204 to the access point 102. The message 202 may be transmitted by an application executing on the device 104. The application may transmit messages to the access point 102 according to a periodic or fixed interval. For example, the application may be a videoconferencing or audio call application that transmits messages according to a periodic or fixed interval to maintain quality of service. As a result, the time between the transmissions of the messages 202 and 204 may be a period 206. The application may also cause the device 104 to transmit a message 208 after transmitting the message 204. The time between the transmissions of the messages 204 and 208 may also be the period 206.

The device 104 may transmit any number of padding messages between transmissions from the application. In the example of FIG. 2, the device 104 transmits a padding message 210 between the transmissions of the messages 204 and 208. As a result, the padding message 210 may create the impression that the device 104 is not transmitting messages according to a periodic or fixed interval (which may also be referred to as breaking up the transmission period). The device 104 may transmit any number of padding messages between transmissions of messages from the application. Additionally, the device 104 may transmit a different number of padding messages between different transmissions of messages from the application. In this manner, the device 104 obfuscates the transmission period of the device 104 or the application, which may make it more difficult to determine that the device 104 is transmitting the messages.

FIG. 2 shows an example in which the device 104 transmits messages and padding messages to the access point 102. It is understood, however, that the same technique may be used to obfuscate a transmission period of the access point 102. For example, the access point 102 may transmit messages to the device 104 according to a transmission period, and the access point 102 may transmit padding messages to the device 104 between transmissions of the messages to obfuscate the transmission period.

FIG. 3 illustrates an example padding message 302 in the system 100 of FIG. 1A. The padding message 302 may be transmitted by an access point (e.g., the access point 102 shown in FIG. 1A) or a device (e.g., the device 104 shown in FIG. 1A) to obfuscate a transmission period of the access point or the device. As seen in FIG. 3, the padding message 302 includes a padding header 304 and padding data 306.

The padding header 304 may include information about the padding message 302. For example, the padding header 304 may indicate a size of the padding message 302. As another example, the padding header 304 may include addresses of the transmitter and the receiver of the padding message 302 (e.g., addresses of the access point and the device). The padding header 304 may also include a bit, flag, field, etc. that indicates that the padding message 302 is a padding message. When the receiver of the padding message 302 analyzes the padding header 304, the receiver may determine from the bit, flag, field, etc. that the padding message 302 is a padding message. The receiver may then disregard or discard the padding message 302.

The padding data 306 may be any type of data added to the padding message 302 (e.g., randomized values, arbitrary values, irrelevant values, etc.). Generally, the padding data 306 is irrelevant to the receiver of the padding message 302 or to an application executing on the receiver. As a result, the padding data 306 may be considered junk data. The transmitter of the padding message 302 may add any amount of padding data 306 to the padding message 302. In some instances, the transmitter may add a random amount of padding data 306 to the padding message 302. In certain instances, the transmitter may add an amount of padding data 306 such that the size of the padding message 302 reaches a size threshold (e.g., which may be specified by a size specification) or matches the size of another message (e.g., a message transmitted by another device). Because the padding header 304 and the padding data 306 are part of a message, the padding header 304 and the padding data 306 may be encrypted like any other transmitted messages. In some embodiments, the message 302 may include a frame check sequence (FCS) field at the end of the message 302.

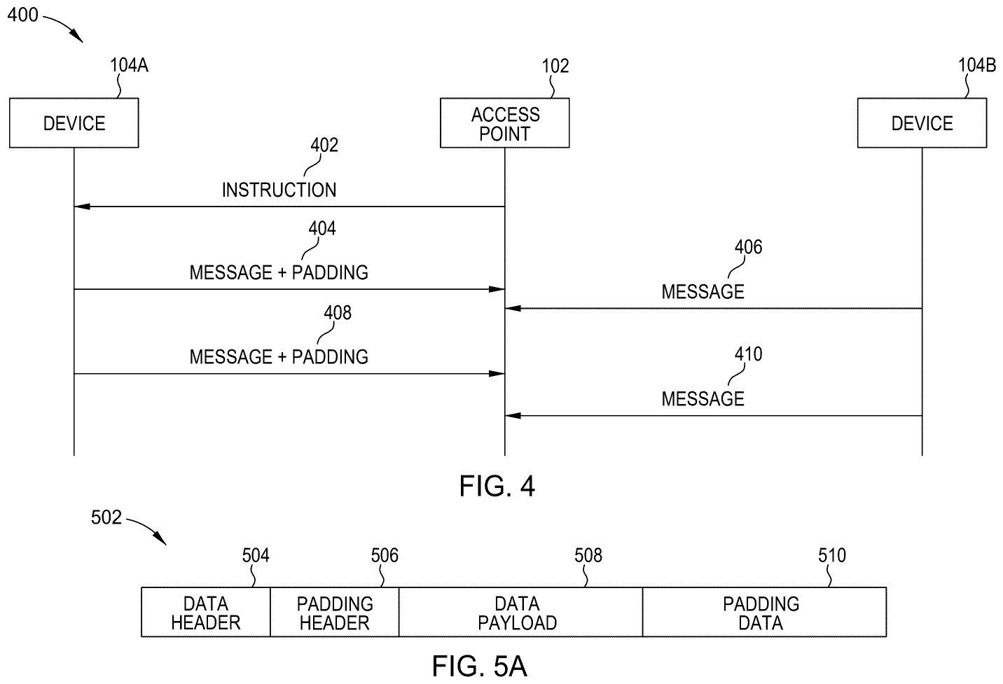

FIG. 4 illustrates an example operation 400 performed by the system 100 of FIG. 1A. Generally, the access point 102 and multiple devices 104 (e.g., the devices 104A and 104B) perform the operation 400. By performing the operation 400, the access point 102 and the devices 104 obfuscate message sizes.

The access point 102 may begin by transmitting an instruction 402 to the device 104A. The instruction 402 may instruct the device 104A to add padding data to messages transmitted by the device 104A. The instruction 402 may also include a size or amount of padding data to add. For example, the instruction 402 may instruct the device 104A to add a random amount of padding data to the messages. As another example, the instruction 402 may instruct the device 104A to add an amount of padding data such that the size of the messages reaches a size threshold (e.g., which may be specified by a size specification) or matches the size of messages transmitted by other devices (e.g., the device 104B).

The device 104A may add padding to messages according to the instruction 402. For example, the device may add a padding header and padding data to a message 404 and then transmit the message 404. The padding header may include information about the padding data added to the message 404. For example, the padding header may indicate where the padding data is positioned within the message 404. As another example, the padding header may indicate a size of the padding data at each position where the padding data is located within the message 404. After transmitting the message 404, the device 104B may transmit a message 406. The message 406 may or may not include padding.

The device 104A may also add padding to a message 408 and then transmit the message 408. The device 104B may also transmit a message 410 (e.g., after transmission of the message 408). The message 410 may or may not include padding. Although the messages 406 and 410 are shown interleaved with the messages 404 and 408, it is understood that the messages 406 and 410 may be transmitted at any time relative to the message 404 or 408.

In some instances, the amount of padding added to the message 408 may be different from the amount of padding added to the message 404. For example, if the instruction 402 instructed the device 104A to add a random amount of padding to each message, then the device 104A may add different amounts of padding to the messages 404 and 408. As another example, if the instruction 402 instructed the device 104A to add an amount of padding to each message so that the size of each message reaches a size threshold (e.g., which may be specified by a size specification) or matches the size of a message transmitted by another device, then the device 104A may add padding to the messages 404 and 408 such that the size of the message 404 and 408 reach the size threshold or match the size of messages transmitted by another device (e.g., the message 406 and 410 transmitted by the device 104B).

If the messages 404 and 408 were transmitted by an application on the device 104A that uses messages with predetermined or fixed sizes (e.g., a videoconferencing or audio call application), then adding padding to the message 404 and 408 may create the impression that the device 104A is transmitting messages that are not the predetermined or fixed sizes. In some instances, the padding may cause the messages 404 and 408 to reach a size threshold (e.g., which may be specified by a size specification) or to have the same size as messages transmitted by other devices. As a result, it may be difficult to distinguish the messages 404 and 408 from messages transmitted by other devices because every message would have the same size.

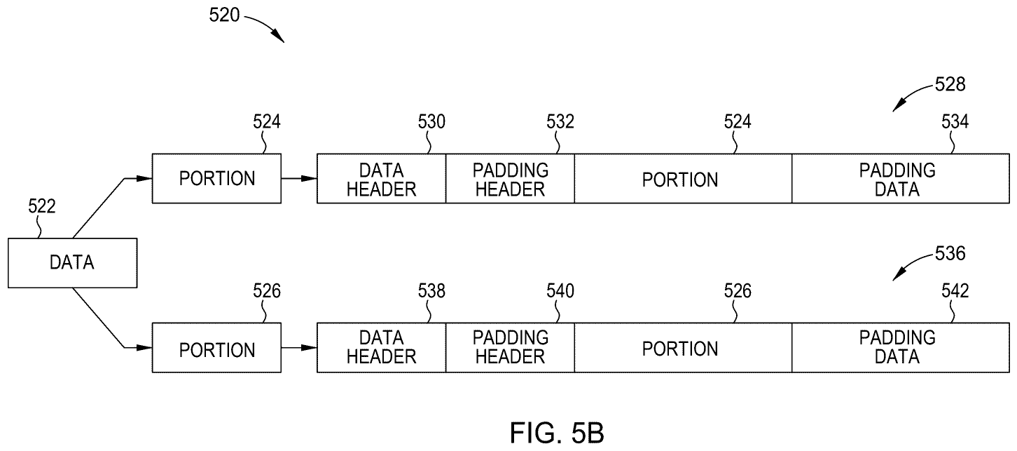

FIG. 5A illustrates an example message 502 in the system 100 of FIG. 1A. Generally, the message 502 may include padding that has been added to the message 502. As seen in FIG. 5A, the message 502 includes a data header 504, a padding header 506, a data payload 508, and padding data 510.

The data header 504 includes information about the data payload 508. For example, the data header 504 may indicate a size of the data payload 508 and a position of the data payload 508 in the message 502. In some instances, the data header 504 may also indicate a total size of the message 502. Using information in the data header 504, a receiver of the message 502 may determine where and how to extract the data payload 508 from the message 502.

The padding header 506 includes information about the padding data 510. For example, the padding header 506 may indicate a size of the padding data 510 and a position of the padding data 510 in the message 502. Using information in the padding header 506, a receiver of the message 502 may determine where the padding data 510 is located in the message 502. The receiver may then disregard or discard the padding data 510. In some instances, the padding header 506 may include a bit, flag, field, etc. that indicates that the message 502 includes padding data 510. By analyzing the bit, flag, field, etc., the receiver may determine that the message 502 includes padding data 510 and discard or disregard the padding data 510. Because the padding header 506 and the padding data 510 are part of the message 502, the padding header 506 and the padding data 510 may be encrypted along with other portions of the message 502.

The data header 504, padding header 506, data payload 508, and padding data 510 may be divided and positioned at any position(s) in the message 502. For example, the padding data 510 may include several blocks of padding data, and each block may be positioned at a separate position within the message 502. In some instances, the blocks may split or separate the data payload 508 into blocks. The data header 504 and padding header 506 may indicate the locations and sizes of the blocks of data payload 508 and padding data 510, respectively. In certain instances, the padding header 506 may be positioned at the beginning of the message 502 or after the data payload 508.

FIG. 5B illustrates an example operation 520 performed by the system 100 of FIG. 1A. An access point (e.g., the access point 102 shown in FIG. 1A) or a device (e.g., the device 104 shown in FIG. 1A) performs the operation 520. By performing the operation 520, the access point or device fragments data into multiple messages with padding.

The access point or device begin with data 522 to be transmitted. The access point or device fragment the data 522 into a portion 524 and a portion 526. The access point or device may fragment the data 522 into any number of portions. The access point or device then include the portions into separate messages. The access point or device may fragment the data 522 into any number of messages. The access point or device may include padding in each message.

In the example of FIG. 5B, the access point or device generates a message 528 using the portion 524. The message 528 includes a data header 530, a padding header 532, the portion 524, and padding data 534. The data header 530 includes information about the portion 524, such as the size of the portion 524 and the position of the portion 524 in the message 528. The padding header 532 includes information about the padding data 534, such as the size of the padding data 534 and the position of the padding data 534 in the message 528. The padding header 532 may also include a bit, flag, field, etc. that indicates that the message 528 includes padding data 534. When the message 528 is received, the receiver may discard or disregard the padding data 534 using the information in the padding header 532.

The access point or device may generate a message 536 using the portion 526. The message 536 includes a data header 538, a padding header 540, a portion 526, and padding data 542. The data header 538 includes information about the portion 526, such as the size of the portion 526 and the position of the portion 526 in the message 536. The padding header 540 includes information about the padding data 542, such as the size of the padding data 542 and the position of the padding data 542 in the message 536. The padding header 540 may also include a bit, flag, field, etc. that indicates that the message 536 includes padding data 542. When the message 536 is received, the receiver may discard or disregard the padding data 542 using the information in the padding header 540. In this manner, the access point or device fragments the data 522 into separate messages with padding.

In some embodiments, the padding data 534 and 542 may separate the portions 524 and 526 such that the portion 524 and 526 do not occupy contiguous portions of the messages 528 and 536. Additionally, the padding data 534 and 542 may not occupy contiguous portions of the message 528 and 536. As a result, the portions 524 and 526 or the padding data 534 and 542 may separate each other in the messages 528 and 536.

In some instances, the padding data 534 and 542 may be random sizes. In this manner, the sizes of the messages 528 and 536 may be different, random sizes, which may obfuscate the sizes of the messages 528 and 536. In certain instances, the padding data 534 and 542 may cause the messages 528 and 536 to be the same size. For example, the padding data 534 and 542 may cause the messages 528 and 536 to reach a size threshold (e.g., which may be specified by a size specification) or to be the same size as a message transmitted by another device. In this manner, the sizes of the messages 528 and 536 may be obfuscated so that it becomes more difficult to determine that the access point or device transmitted the messages 528 and 536.

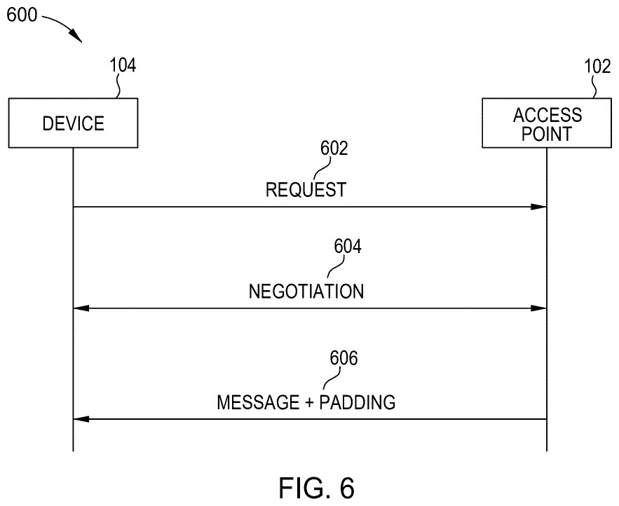

FIG. 6 illustrates an example operation 600 performed by the system 100 of FIG. 1A. The access point 102 and the device 104 perform the operation 600. By performing the operation 600, the device 104 negotiates padding from the access point 102.

The device 104 begins by communicating a request 602 to the access point 102. The request 602 may request the access point 102 to add padding to messages communicated by the access point 102 to the device 104. For example, the request 602 may be a stream classification service (SCS) request (e.g., an add request, change request, remove request, etc.). The SCS director list may include a requested treatment for the downlink flow, and may also include a flag, field, element, etc. requesting padding. The flag, field, element, etc. may specify the requested padding (e.g., target payload size, whether to insert of padding-only frames, etc.). As another example, the request 602 may be a mirrored stream classification service (MSCS) request frame. The user priority control field may include a flag, field, element, etc. to request padding. The request 602 may include a field, element, etc. that describes the type of padding requested.

The access point 102 receives the request 602 and performs a negotiation 604 with the device 104. For example, the access point may accept, reject, or suggest an alternative to the device 104. The access point 102 may use additional classifiers to determine the best return padding. The access point 102 may use traffic identification engines to determine traffic subject to classification. The access point 102 may pad downstream traffic even if the device 104 has not requested padding, or the access point 102 may apply a different padding than the one requested by the device 104. In some embodiments, the access point 102 uses metrics related to the number of devices 104, the types of downstream frames (e.g., single user, multi-user, etc.) and their sizes to dynamically determine the best padding option for each device 104. The access point 102 may signal to the devices 104 that padding will be dynamic.

The access point 102 may then communicate a message 606 that includes padding to the device 104. For example, the message 606 may include a padding header and padding data. The device 104 may discard or disregard the padding data when processing the message 606. In this manner, the access point 102 and the device 104 may disguise or obfuscate the size of messages transmitted by the access point 102 to the device 104.

In some instances, the access point 102 may transmit padding messages (e.g., padding-only messages) in between transmissions of messages to the device 104. The padding messages may disguise or obfuscate a transmission period of the messages.

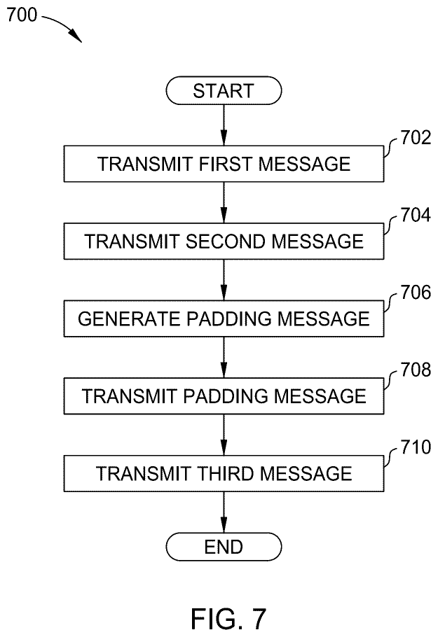

FIG. 7 is a flowchart of an example method 700 performed by the system 100 of FIG. 1A. In certain embodiments, an access point (e.g., the access point 102 shown in FIG. 1A) or a device (e.g., the device 104 shown in FIG. 1A) performs the method 700. By performing the method 700, the access point or device use padding messages to disguise or obfuscate the transmission period of messages.

At 702, the access point or device transmits a first message. The first message may include a data payload. At 704, the access point or device transmits a second message. The second message may also include a data payload. The access point or device may transmit the first message and the second message according to a fixed transmission period. The time between the transmission of the first message and the transmission of the second message may be the transmission period.

At 706, the access point or device generates a padding message. The padding message may include a padding header and padding data (e.g., but no data payload). The padding header may indicate a size of the padding data. The padding header may also include a bit, flag, field, element, etc. that indicating that the padding message includes padding data. In some instances, the size of the padding message may be the same as the size of the first message or the second message. At 708, the access point or device transmits the padding message. The time between the transmission of the padding message and the transmission of the second message may be less than the transmission period.

At 710, the access point or device transmits a third message. The third message may include a data payload. The access point or device may transmit the third message according to the transmission period. The time between the transmission of the second message and the transmission of the third message may be the transmission period. Because the padding message is not transmitted according to the transmission period, the padding message may create the appearance that the access point or device is not transmitting messages according to the transmission period.

In summary, a network uses padding information to obscure, disguise, or obfuscate traffic patterns by padding payload into data frames or by inserting padding frames into exchanges. For example, a device that may be using an application that transmits messages of fixed sizes or at fixed intervals may generate a padding message that includes a padding header and padding data (e.g., lacks a data header and a data payload). As a result, the padding message may include information that is not relevant to or not used by the application, and a receiving access point may discard or disregard the padding message. The device may transmit the padding message in between transmissions made by the application. As a result, the padding message may make it more difficult for a malicious user to determine that the device is transmitting according to the transmission period or at the fixed transmission interval.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless device comprising:
one or more memories; and
one or more processors communicatively coupled to the one or more memories, the one or more processors configured to, individually or collectively, perform an operation comprising:
transmitting, to an access point, a first message at a first time;
transmitting, to the access point, a second message at a second time after the first time, wherein a difference between the second time and the first time is a transmission period;
generating a padding message comprising a first padding header and first padding data;
transmitting, to the access point, the padding message at a third time after the second time, wherein a difference between the third time and the second time is less than the transmission period; and
transmitting, to the access point, a third message at a fourth time after the third time, wherein a difference between the fourth time and the second time is the transmission period.

2. The wireless device of claim 1, wherein the padding message lacks a data header and a data payload.

3. The wireless device of claim 1, wherein a size of the first padding data is random.

4. The wireless device of claim 1, wherein the first message comprises a data header, a data payload, a second padding header, and second padding data, wherein the data header comprises information about the data payload, and wherein the second padding header comprises information about the second padding data.

5. The wireless device of claim 4, wherein the operation further comprises:
receiving, from the access point, an instruction indicating a size of the first message; and
determining, based on a size of the data payload and the size of the first message, a size of the second padding data.

6. The wireless device of claim 5, wherein the second padding data obfuscates the size of the first message based on messages from a second device to the access point being of the size of the first message.

7. The wireless device of claim 5, wherein the size of the padding data causes the size of the first message to equal a size specification.

8. The wireless device of claim 4, wherein the operation further comprises fragmenting data into a first portion and a second portion and wherein the data payload comprises the first portion.

9. The wireless device of claim 1, wherein the operation further comprises:
transmitting, to the access point, a request for padding; and
receiving, from the access point and based on the request, a second message comprising a data header, a data payload, a second padding header, and second padding data.

10. The wireless device of claim 1, wherein the transmission period is a transmission period of a videoconferencing application or an audio call application executed by the wireless device.

11. A method comprising:
transmitting, to an access point, a first message at a first time;
transmitting, to the access point, a second message at a second time after the first time, wherein a difference between the second time and the first time is a transmission period;
generating a padding message comprising a first padding header and first padding data;
transmitting, to the access point, the padding message at a third time after the second time, wherein a difference between the third time and the second time is less than the transmission period; and
transmitting, to the access point, a third message at a fourth time after the third time, wherein a difference between the fourth time and the second time is the transmission period.

12. The method of claim 11, wherein the padding message lacks a data header and a data payload.

13. The method of claim 11, wherein a size of the first padding data is random.

14. The method of claim 11, wherein the first message comprises a data header, a data payload, a second padding header, and second padding data, wherein the data header comprises information about the data payload, and wherein the second padding header comprises information about the second padding data.

15. The method of claim 14, further comprising:
receiving, from the access point, an instruction indicating a size of the first message; and
determining, based on a size of the data payload and the size of the first message, a size of the second padding data.

16. The method of claim 15, wherein the second padding data obfuscates the size of the first message based on messages from a second device to the access point being of the size of the first message.

17. The method of claim 15, wherein the size of the padding data causes the size of the first message to equal a size specification.

18. The method of claim 14, further comprising fragmenting data into a first portion and a second portion and wherein the data payload comprises the first portion.

19. The method of claim 11, further comprising:
transmitting, to the access point, a request for padding; and
receiving, from the access point and based on the request, a second message comprising a data header, a data payload, a second padding header, and second padding data.

20. An access point comprising:
one or more memories; and
one or more processors communicatively coupled to the one or more memories, the one or more processors configured to, individually or collectively, perform an operation comprising:
receiving a first message transmitted by a wireless device at a first time;
receiving a second message transmitted by the wireless device at a second time after the first time, wherein a difference between the second time and the first time is a transmission period;
receiving a padding message transmitted by the wireless device at a third time after the second time, wherein the padding message comprises a first padding header and first padding data and wherein a difference between the third time and the second time is less than the transmission period;
discarding the padding data based on the padding header; and
receiving a third message transmitted by the wireless device at a fourth time after the third time, wherein a difference between the fourth time and the second time is the transmission period.
